(19) United States
(12) Patent Application Publication
(10) Pub. No.: US 2009/0138349 A1
(43) Pub. Date: May 28, 2009

(54) ARTIST SPONSORSHIP

(75) Inventors: Steven Drucker, Bellevue, WA (US); Adam Tipton Berns, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/946,442

(22) Filed: Nov. 28, 2007

(51) Int. Cl. G06Q 40/00; G06Q 30/00

(52) U.S. Cl. 705/14; 705/37; 705/36 R

(57) ABSTRACT

The claimed subject matter relates to an architecture that can facilitate sponsorship of authors as well as the material or original work produced by those authors. The architecture can issue a virtual share by which participants can personally invest in an author or his or her content to receive ownership rights of future earnings. Based partially upon the notion that a share that performs well is indicative of consumer interest in the underlying asset, the architecture can select those assets based upon the performance of the virtual share. Accordingly, sponsorship is more likely to be based upon merit as seen by the consuming public rather than based upon protectionist principles.

### BACKGROUND

Conventionally, authors and other artists are not exposed to equal opportunities in the marketplace, largely due to effective regulation existing in most media or entertainment fields by commercial oligopolies. These oligopolies maintain rigid protectionist policies that essentially preclude any reasonable chance for large scale success except by way of signing a deal with one of the oligopolies, who therefore effectively decide who will and who will not be popular regardless of the merit of the underlying product or its appeal to consumers.

For example, in the music industry, a primary way to gain exposure to an audience is by way of radio stations that premiere new music, often on a daily basis. Listeners often hear something they like (relative to the quality of whatever else is played) for the first time from a radio station, then, perhaps, visit a local media outlet to buy the album from the artist who performed that song. While radio is free to the end-user, it is (ostensibly) funded by commercial advertisements, which, in theory makes for a nice free market association, wherein music is provided to the consumers free of charge in exchange for, say, a cola company using air time to increase sales, enhance their trade name or goodwill, etc.

Generally, the cola company who helps fund the radio station has no say (and normally does not care) what songs are played as long as the audience likes them, yet, oddly nearly every radio station in the United States maintains a “play list,” that indicates the set of songs a disc jockey (DJ) is allowed to play. A song that is not on the play list cannot be aired by the DJ no matter how good the song is, no matter how much the DJ (who is normally considered to have autonomy) likes the song, or no matter who or how many listeners call in to request the song, the last of which amply indicates that appealing to the audience is not the primary concern of most radio stations, which is counter to free market principles and would probably run counter to what most individuals (as well as the cola company who is paying the bill) believes.

In other words, meeting the demand of the market is not the primary concern of the radio stations. Rather, given that most radio “play lists” include songs almost exclusively from known recording studios, but lack virtually any song from an independent artist or producer, it is readily apparent that this object takes a back seat to certain protectionist practices of the recording labels (e.g., protectionist oligopolies). Similar protectionist practices exist in virtually every field of media or entertainment, making it nearly impossible for an independent to succeed and also making it impossible for the audience to be exposed to work product that might be of great interest.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises a computer implemented architecture that can facilitate sponsorship of authors and/or associated authored content. To these and other related ends, the architecture can register an author and issue one or more virtual shares for listing on an exchange. The virtual share(s) can be associated with either or both the author as well as the authored content (e.g. work product or copyrighted material). The architecture can also host content related to the author or the copyrighted material and can also provide access to the content to interested parties, either free of charge or on a pay basis.

In addition, the architecture can select the author or the author's work for sponsorship based upon performance of the virtual share. According to an aspect of the claimed subject matter, sponsorship can include a substantive investment in, e.g. funding, marketing, promoting, and/or managing the author/work product in a manner similar to business enterprises such as publishing houses, recording labels, producing studios, and so on. Moreover, the selection for sponsorship, as it can be based upon the performance of one or more virtual shares, can more accurately reflect the desires of the audience as well as be in accord with successful free market principles. Essentially, the interest of the market can be determined by the successes of the virtual share, hence, the risk in sponsorship is reduced. Furthermore, a successful share can be indicative of what the market wants or likes, which is precisely the types of content that will generally be selected for sponsorship and, therefore, provided to the audience. Appreciably, such features teach away from current market trends and conventional wisdom, which both tend to focus on consolidating decisions to sponsor authors in the hands of a small number of decision-makers; and further leave the audience with very little in the way of meaningful input.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer implemented system that can facilitate sponsorship of authors and/or associated authored content.

FIG. 2 depicts a block diagram that depicts features of the registration component in further detail is provided.

FIG. 3 is a block diagram that illustrates features of the hosting component 106 in further detail.

FIG. 4 is a block diagram that depicts features of the sponsorship component in further detail.

FIG. 5 depicts a block diagram of a computer implemented system further comprising a virtual exchange.

FIG. 6 is an exemplary flow chart of procedures that define a computer implemented method for facilitating sponsorship of authors or copyrighted material associated with the authors.

FIG. 7 illustrates an exemplary flow chart of procedures that define a computer implemented method for defining contractual rights and/or obligations in association with the registering.

FIG. 8 depicts an exemplary flow chart of procedures defining a computer implemented method for facilitating additional aspects in connection with facilitating sponsorship of authors and/or associated authored content.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

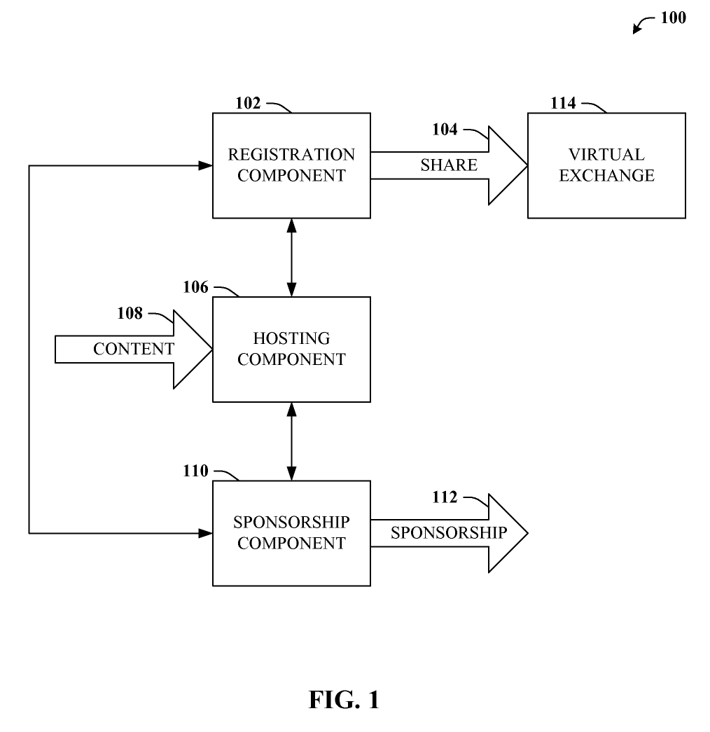

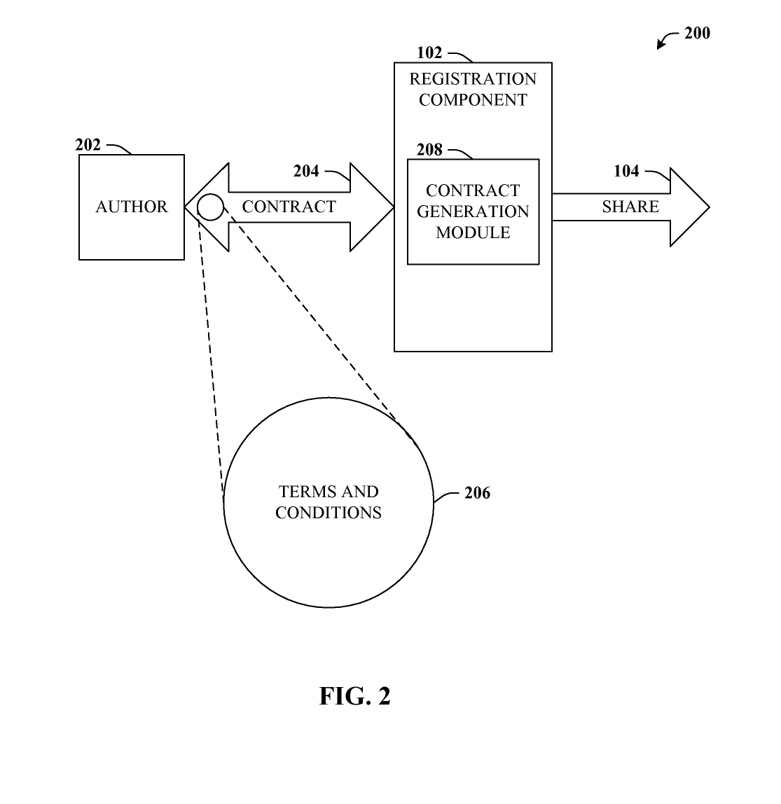

Referring now to the drawing, with reference initially to FIG. 1, computer implemented system 100 that can facilitate sponsorship of authors and/or associated authored content is depicted. Generally, system 100 can include registration component 102 that can register an author for listing on, say, an exchange, wherein the author or associated content such as copyrighted work product can be virtualized as a financial instrument. In accordance therewith, registration component 102 can issue virtual share 104 as the financial instrument that is representative of the underlying creative entity asset (e.g., either or both of content or the author). Additional features with respect to registration component 102 can be found with reference to FIG. 2.

As used herein, the term “author” is intended to mean an individual, group, agent, or entity that creates original work (e.g., copyrighted material), including derivative works. Hence, an author can be a musician, a writer, a director, a poet, an artist, an architect, a programmer, a chef, and so forth. Likewise, the copyrighted material can be music (sheet music, performed, or recorded), a novel, a play or screenplay, a short story, a greeting card, an advertisement, a slogan, or another type of prose or poetry; a feature film, a documentary, a commercial or video short as well as other types of video productions; a painting, a sculpture, a building, a design, a graphic; a program, application, applet, or utility, etc. While several examples of each are listed supra, other types of authors and their respective work product certainly can exists and can be included within the spirit and scope of the claimed subject matter. Therefore, the claimed subject matter need not be limited to only the examples provided.

To provide a concrete illustration, consider a music group/band. The band can represent the author and songs or music created by the band can be the copyrighted material. Appreciably, virtual share 104 can be issued to correspond to one or both of the band or the band's music as well as for compilations thereof. For example, one or more virtual shares 104 can be issued to correspond to each of the band's numerous songs, to an album comprising several songs, as well as to the band itself once the band registers with registration component 102. The allocation of virtual shares 104 can be based upon a predetermined format, dynamically determined, decided by the host, or decided by the author. Generally, virtual share 104 is a virtualized financial instrument intended to represent a medium of exchange, a measure of value of the underlying asset, partial ownership of the underlying asset, or in some cases a price for acquisition of the underlying asset. Moreover, a single owner can obtain multiple virtual shares 104 for a single underlying asset (e.g. author or associated content) just as many disparate owners can each obtain one or more virtual shares 104.

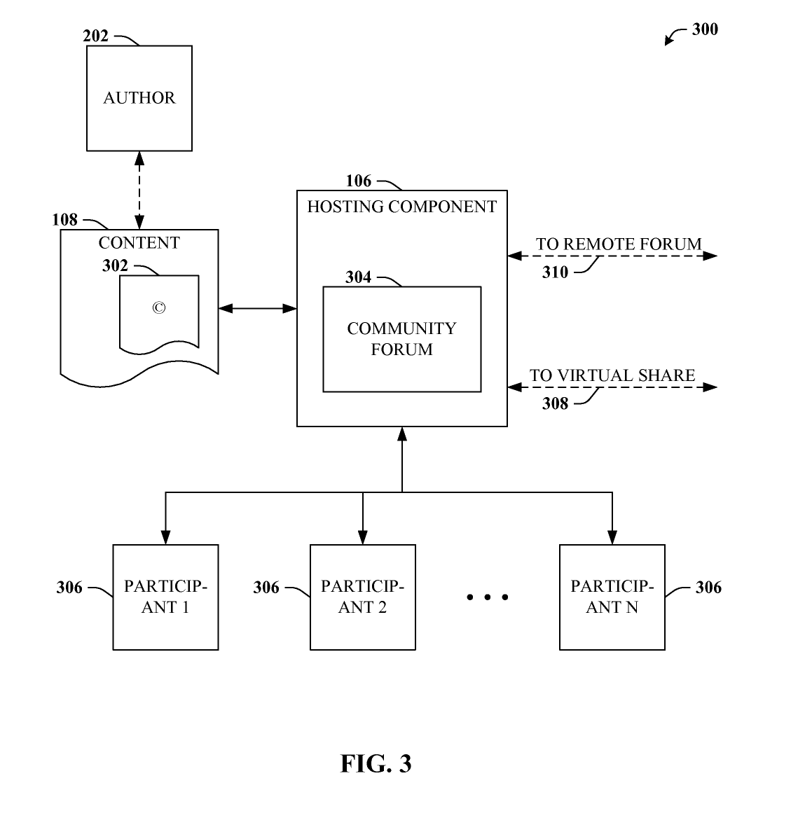

In addition, system 100 can also include hosting component 106 that can receive content 108 that is associated with the author. It is to be understood that content 108 can include the copyrighted material as well as a variety of other types of information such as descriptions, photos, bios, histories, schedules, and so on. Furthermore, hosting component 106 can provide access to some or all of content 108, which is discussed in more detail with reference to FIG. 3 infra.

System 100 can also include sponsorship component 110 that can select the author and/or content for sponsorship. In accordance with one aspect of the claimed subject matter, selection for sponsorship 112 can be based upon performance of the virtual share issued by registration component 102. For example, performance can be reflected by a change in price of virtual share 104 relative to changes in other virtual shares associated with another (often similarly categorized) underlying asset. The price of virtual share 104 can be governed entirely by supply/demand market forces similar to conventional securities markets. Additionally or alternatively, the price can be dependent upon a variety of other factors such as a number of content accesses, downloads, or other transactions that indicate interest or support, a number of purchases of virtual share 104 (e.g., demand side only), and so forth. Regardless, upon attaining a threshold performance value, sponsorship component 110 can automatically select the creative entity associated with virtual share 104 for sponsorship 112. Upon selecting the creative entity, e.g., a host can be notified of the selected creative entity as well as other relevant data such as virtual share 104 metrics, content 108, and so forth.

As used herein, sponsorship 112 is intended to mean a material and/or substantial investment in the promotion of the author or the author's work product, which can vary based upon the type of author and/or work product. Sponsorship 112 can be substantially similar to that which is provided by media-based businesses or firms such as record labels, publishing houses, production studios, art galleries and the like, and can also be based upon the type of work product in question. For instance, returning to the previous example of a music band, sponsorship 112 can refer to funding, marketing, promoting, and/or managing the band including the organization of a performance tour or negotiating with radio stations to aid in popularizing or branding the band as well as in dissemination of the band's work product; physically printing a compact disc (CD) and/or distributing the CD to retailers and so forth.

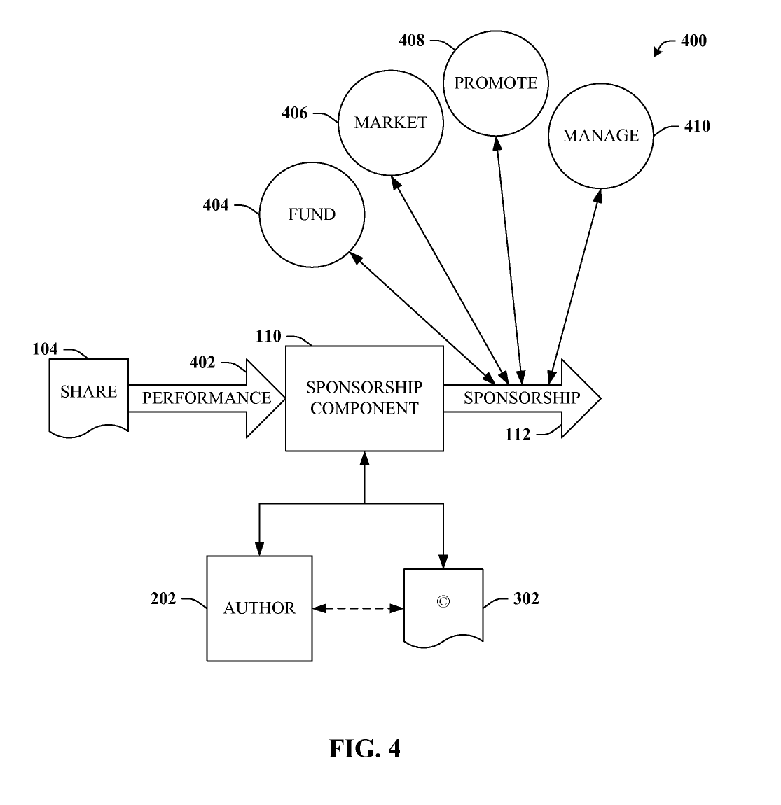

Naturally, sponsorship 112 will generally differ based upon the type of copyrighted material such that sponsorship for a novelist, a film director, etc. will differ in character, but can have similar results or goals in those respective fields. Accordingly, a potentially unforeseen benefit of the foregoing is that sponsorship 112 can potentially compete with existing oligopolies that inequitably regulate or control many of these artistic fields and decide for the public what will be available for consumption. Moreover, since sponsorship 112 can be based upon performance of virtual share 104, which, in turn, can be based upon public opinion, support, interests, or taste (described infra), many of these fields or industries can at last be opened up to a free market, allowing the market to choose what content will be available rather than the existing oligopolies that conventionally tend to have a chilling effect on creative expression. Additional description relating to sponsorship component 110 can be found with reference to FIG. 4.

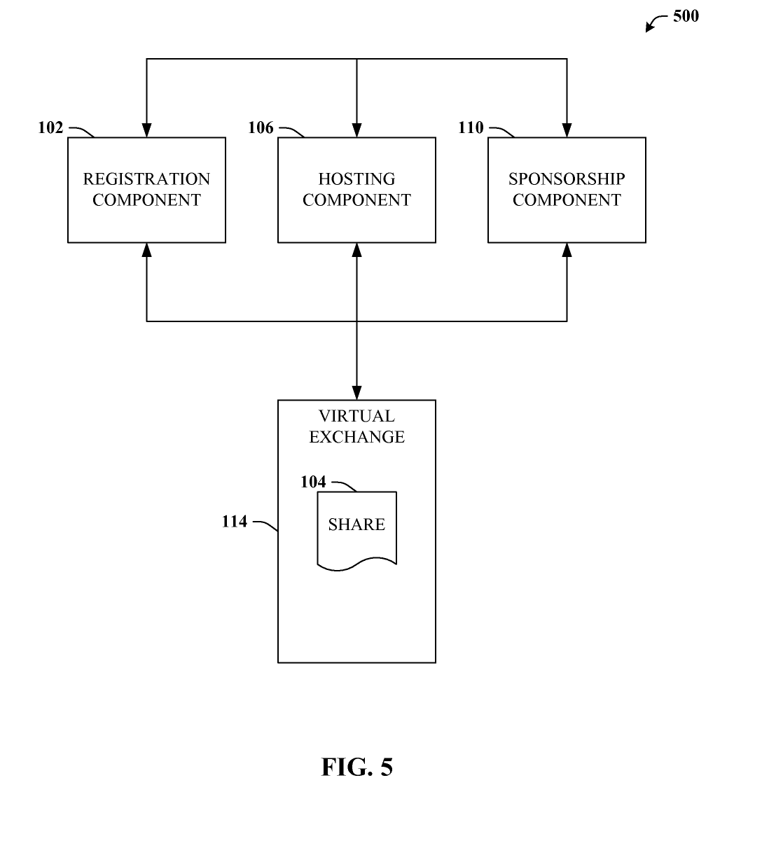

In addition, system 100 can also include virtual exchange 114 that can list virtual share 104 for sale at a share price. It should be appreciated that the share price can be either static or dynamic. For instance, the share price can change over time based upon transaction indicative of interest or support (e.g., downloads, virtual share 104 purchases, clicks, PageRank metrics . . . ). Alternatively, the share price can be static and can represent an investment in the underlying asset that can further the goal of sponsorship 112. In such cases, the host can (but need not) receive all or portions of the proceeds from sales of the virtual share until, say, a certain amount of initial capital is acquired to implement sponsorship 112. In another aspect, purchasing virtual share 104 can entitle the purchaser to future revenues stemming from sponsorship 112. While not necessarily always the case, in one aspect, purchasing virtual share 104 can provide the purchaser rights to download, view, listen to, or otherwise consume portions of content 108 such as copyrighted work product. Further description of virtual exchange 114 can be found in connection with FIG. 5

Turning now to FIG. 2, system 200 that depicts features of registration component 102 in further detail is provided. In general, system 200 can include registration component 102 that can register author 202 for listing and that can issue virtual share 104, as previously described. In addition, registration component 102 can include or be operatively coupled to contract generation module 208. Contract generation module 208 can provide contract 204 to author 202, wherein contract 204 can include terms and conditions 206 associated with the listing. In one aspect, terms and conditions 206 can include rights associated with hosting the copyrighted material (e.g., work product of author 202). For example, these rights can allow, in a legal sense, hosting component 106 to receive, distribute, and/or maintain content 108.

Terms and conditions 206 can also include rights to distribute the copyrighted material free of charge or, in another aspect to distribute the copyrighted material at the share price of virtual share 104. Here, the choice can be based upon a decision by author 202, upon market factors, or be predetermined in accordance with the type of work product at hand. If a charge is associated with distribution of the material, contract 204 can include terms governing allocation of the profits between author 202 and the host. In addition, terms and conditions 206 can include an obligation on behalf of the host to facilitate the sponsorship 112. For example, if virtual share 104 reaches a certain level or, in another case, a certain number of virtual shares 104 are sold, then the obligation can be triggered. In either case, whether virtual share 104 rises in price or a certain number have been sold, this can be indicative of dramatic interest in the underlying subject matter (e.g., author 202 or associated work product) of virtual share 104. Hence, the host can be reasonably sure that author 202 represents a sound investment. Moreover, author 202 can then receive the promotion (by way of sponsorship 112) that is otherwise so difficult to obtain in today's marketplaces, so this situation can represent a win-win for both sides.

With reference now to FIG. 3, system 300 that illustrates features of hosting component 106 in further detail is depicted. Generally, system 300 can include hosting component 106 that can receive content 108 that is associated with author 202 and such content can comprise copyrighted material 302 as well as other information relating to author 202. Moreover, hosting component 106 can provide access to all or portions of content 108 to, e.g., any number of participants 306. Participants 306 can be individuals or entities who are interested in content 108 and/or interested in learning more about content 108. In addition, participants 306 can be owners of one or more virtual share(s) 104 or individuals or entities interested in purchasing one or more virtual share(s) 104, as well as author 202.

In accordance therewith, hosting component 106 can provide community forum 304 to participants 306. Community forum 304 can be a centralized location for which participants 306 can browse for content 108, learn more about authors 202, as well as other activities. Community forum 304 is generally intended to be an electronic forum and can be or include a website, a blog, a bulletin board, a content server, and so on. In addition community forum 304 can be accessible by way of numerous types of devices such as personal computers, cellular phones, media players, readers, etc.

It is to be understood that participants 306 can create spaces on community forum 304 to decorate and/or moderate as those participants 306 see fit. According to one aspect of the claimed subject matter, participants 306 can promote or advertise author 202 or content 108. For example, consider the music band introduced supra that creates their own space on community forum 304, where several songs can be downloaded free of charge. One particular participant 306 downloads a few songs and is amazed by the quality of the work product and further surprised that no recording label has picked this band up. Participant 306 subsequently buys one or more virtual share(s) 104 associated with the band and further adds promotional material for the author 202 to her own successful space on community forum 304 so all of her friends can be exposed to this fantastic new band.

Hence, participant 306 can not only invest financially in the band, but can also become actively involved in promoting the band (and her own economic interests), with a goal of obtaining sponsorship 112 for the band, which can be far, far more likely than the band “getting discovered” by way of the traditional means. Thus, participant 306 can provide references or links to virtual share 104 from her space (as illustrated by reference numeral 308) so that other interested parties can also invest in author 202, and all parties involved can benefit economically by doing no more than what they might otherwise do: The band creates good music and tries to gain a following, participants 306 appreciate the excellent work product of the band and tell their friends to get them interested too. Ultimately, upon sponsorship 112, all parties involved stand to gain substantially, as is detailed more thoroughly with reference to FIG. 4.

In addition, hosting component 106, while able to host community forum 304, can in addition or in the alternative interface with existing a remote community forum or forums as noted with reference numeral 310. Remote forums can be, for example, media forums that relate to media similar to content 108.

Referring now to FIG. 4, system 400 that depicts features of sponsorship component 110 in further detail is illustrated. In general, system 400 can include sponsorship component 110 that can select author 202 and/or associated copyrighted material 302 for sponsorship based upon, e.g. performance 402 of virtual share 104. Given that consumers generally vote with their pocketbooks, the dynamics associated with virtual share can be indicative of popularity of author 202 or material 302. Sponsorship component 110 can analyze virtual share 104 transactions, history, sales, price level, etc. (e.g., performance 402) in order to determine if sponsorship 112 is warranted and/or a potentially profitable venture.

With the foregoing in mind, sponsorship component 110 selects author 202 based upon agreed upon conditions 206 set forth in contract 204 such as when virtual share 104 reaches a predetermined level or when a designated number of virtual shares 104 are sold. Even absent conditions 206 of contract 204 being met, sponsorship component 110 can choose author 202 for sponsorship 112 merely because it is determined or inferred to be a profitable investment. In accordance therewith sponsorship component 110 can examine performance 402 relating to share 104 as well as other information and/or apply various machine learning techniques to generate a recommendation relating to sponsorship 112. Sponsorship component 112 can also employ similar techniques to establish a baseline price for virtual share 104 based upon, e.g., current name recognition, current supporting base, a type of copyrighted material 302, current market conditions, and so forth.

In particular, sponsorship component 110 can examine the entirety or a subset of the data available and can provide for reasoning about or infer states of the system, environment, and/or user from a set of observations as captured via events and/or data. An inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

Still referring to FIG. 4, once author 202 or content 302 has been identified and/or selected for sponsorship 112, it is to be appreciated that sponsorship 112 can take the form of funding 404, marketing 406, promoting 408, or managing 410. In particular, a tour for author 202 such as a book signing, musical concerts, or the like can be funded, marketed, promoted, managed, etc. Similarly, copyrighted material 302 such as a novel or CD can be physically printed and/or distributed, and this as well can be managed, marketed, funded, or promoted in accordance with sponsorship 112. Of course, other examples of sponsorship 112 can exist and can be included within the scope of the appended claims.

Upon implementation of sponsorship 112, the music band could achieve even wider success. Along with this success, due to album sales, concert tours, and so on, there is a substantial likelihood that sponsorship 112 will generate earnings. According to an aspect of the claimed subject matter, earnings generated in accordance with sponsorship 112 can be allocated to an owner of the virtual share 104, who invested value in the band and might help promote the band to others. Moreover, earnings can also be distributed between the band and the host providing sponsorship 112. The percentages allocated to each party can be provided for in contract 204 and can also vary based upon ownership of virtual share 104, a cost basis for virtual share 104, a time of purchase of virtual share 104, or in other ways.

For example, contract 204 can specify, say, 30% of earning generated by activities associated with sponsorship 112 will be allocated to the host, 30% will be allocated to the band, and 40% will go to owners of virtual share 104. Of the 40% allocated to owners, this can be distributed equally on a per virtual share 104 basis. Alternatively, owners who bought at early stages can be entitled to greater allocation per virtual share 104 than other owners making purchases at later stages. In the case where virtual share 104 is statically set, this metric can be a function of a time in which virtual share 104 was purchased. In the case where the price of virtual share 104 is dynamic, then the allocation can be based upon a cost basis similar to well-known securities market transactions.

It is to be appreciated that increasing or decreasing the allocation of earnings to the host can create a corresponding increase or decrease in a performance threshold of virtual share 104 necessary to trigger sponsorship 112. Hence, if the host is allocated relatively small portions of earnings, then the performance of virtual share 104 can be scaled to represent the increased risk-reward ratio associated with the host. However, such can be mitigated to a degree by other terms and conditions 206 of contract 204. For example, certain portions of content 108 (e.g. copyrighted work product) can be accessed on a pay basis, with substantial portions of the proceeds going to the host. Thus, by providing a mechanism for allocating value to the host initially, greater allocation of earnings associated with sponsorship 112 activities can be assigned to the band or the virtual share 104 owners without significantly reducing the likelihood of sponsorship 112 occurring.

Similarly, increasing or decreasing the allocation of earnings to owners of virtual share 104 can affect the behavior of those owners. For instance, allocating a significant portion of the earnings to owners can elicit a greater number of purchases of virtual share 104 as well as elicit more active participation by owners in promoting the band. It should be understood that earnings allocated need not necessarily be in the form of money, but can instead be other types of currency, assets, incentives, or rewards.

With reference now to FIG. 5, system 500 further comprising a virtual exchange is depicted. System 500 can include registration component 102 that can register author 202 for listing on virtual exchange 114 and that can issue virtual share 104 corresponding with author 202 or associated work product 302 as the underlying asset. Furthermore, system 500 can include hosting component 106 that can receive content 108 associated with author 202 (portions of which can be work product/material 302) and that can provide to participants 306 access to content 108. System 500 can also include sponsorship component 110 that can select author 202 and/or material 302 for sponsorship 112 based upon performance 402 of virtual share 104.

In addition, system 500 can also include virtual exchange 114 that can list virtual share 104 for sale at a share price. In one aspect, the share price need not change or the price need not be a function of supply versus demand. For example, the share price can be static and can represent an investment in the underlying asset that can further the goal of sponsorship. In this case, the host can (but need not) receive all or portions of the proceeds from sales of the virtual share until, say, a certain amount of initial capital is acquired to implement sponsorship 112. In another aspect, purchasing virtual share 104 can entitle the purchaser (e.g., participant 306) to future revenues stemming from sponsorship 112. While not necessarily always the case, in one aspect, purchasing virtual share 104 can provide the purchaser (e.g., participant 306) rights to download, view, listen to, or otherwise consume copyrighted material 302.

According to another aspect of the claimed subject matter, virtual exchange 114 can behave more like existing exchanges, wherein the price of virtual share 104 can fluctuate as a function of supply and demand, similar to a spot market for commodities or an exchange for securities. Hence, virtual exchange 114 can provide for both buying and selling of virtual share 104, wherein the price will tend to rise when there are more buys than sells and, in contrast, fall when there are more sells than buys.

In this case, virtual exchange 114 can further provide participants 306 to place a bid for the share at a bid price (normally below the current share price); or allow participants 306 to place an order to sell virtual share at an ask price (normally above the current share price). It is to be appreciated that in the latter case, an owner of virtual share can forego the earnings potential for future owners (e.g., from revenues resulting from sponsorship 112) in order to liquid the share now. According to certain implementations a “short” sale of virtual share 104 might also be allowed.

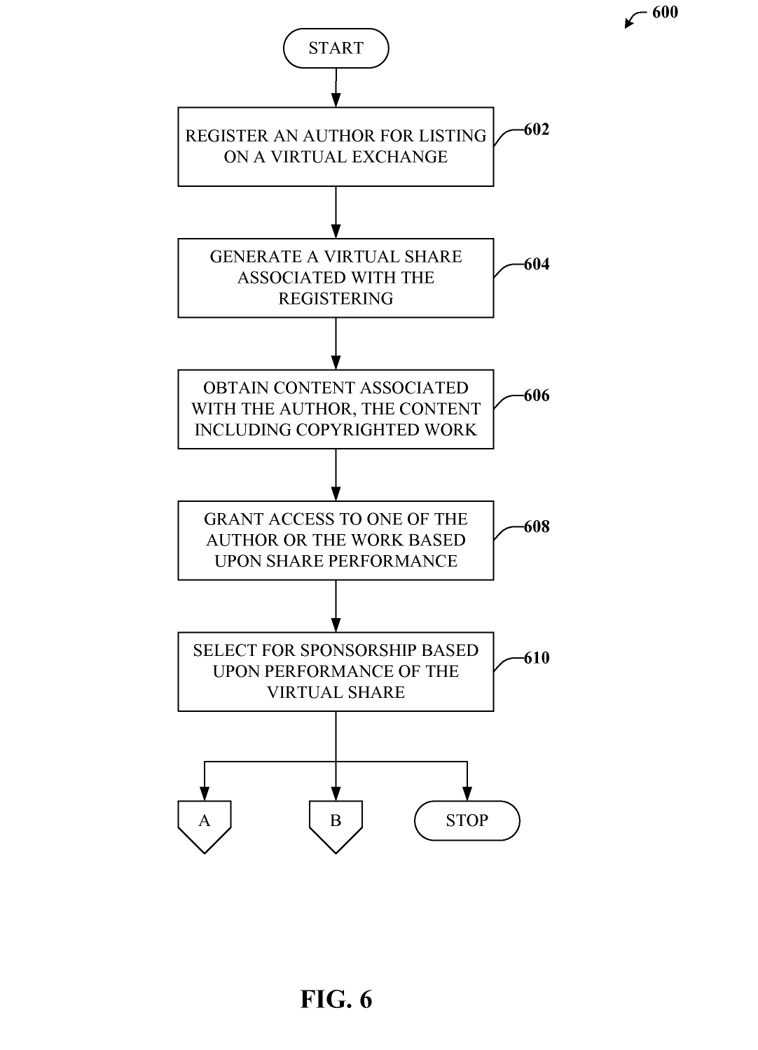

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 6, exemplary computer implemented method 600 for facilitating sponsorship of authors or copyrighted material associated with the authors is illustrated. Typically, at reference numeral 602, an author can be registered for listing on a virtual exchange. It is to be understood that while the author is registered, the underlying asset that will be associated with the listing can be work product of the author rather than the author herself.

At reference numeral 604, one or more virtual shares can be generated in accordance with the act of registering described at reference numeral 602. The virtual share can be associated with the underlying asset (e.g., the author and/or work product) and can represent ownership in future earnings of that asset. At reference numeral 606, content associated with the author can be obtained. The content can include information about the other or the author's work as well as include copyrighted material created by the author.

At reference numeral 608, participants can be granted access to portions of the content. Participants can be essentially any party that is in some way interested in the content provided. It is to be appreciated that in some cases all the content available can be accessed, whereas in other cases some content may only be accessible in connection with a purchase of virtual shares. At reference numeral 610, at least one of the author or the copyrighted material can be selected for sponsorship based upon performance of the virtual share. Generally, if a large number of shares are purchased and/or the value of the share price rises, then the author/content stands a better chance at sponsorship even though, conventionally, aspects involved in sponsorship can be an expensive and/or risky endeavor.

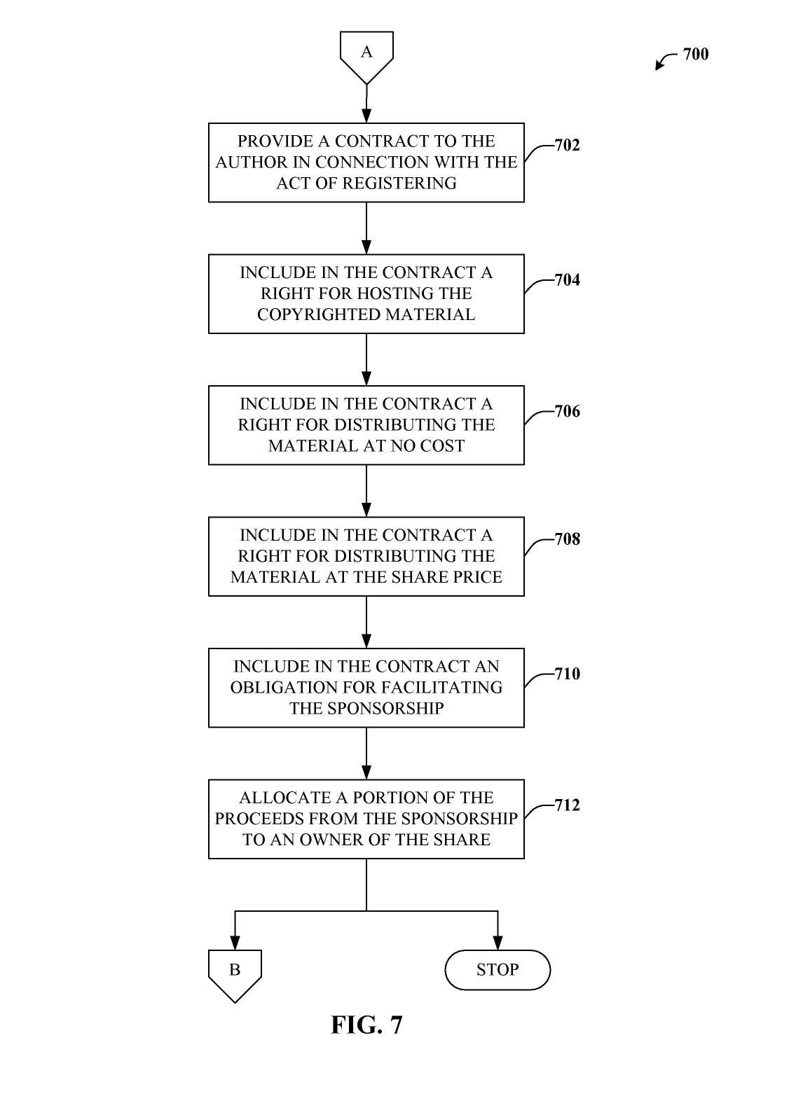

With reference now to FIG. 7 computer implemented method 700 for defining contractual rights and/or obligations in association with the registering is provided. In general, at reference numeral 702, a contract can be provided to the author in connection with the act of registering discussed at reference numeral 602 of FIG. 6. Typically, the contract will be constructed by a contract generation module, but such need not be the case for all terms or conditions of the contract. For example, the author can select one or more terms and conditions as preferences from a set provided during registration or other negotiation stage. Appreciably, selection of certain terms and conditions may enable other terms and conditions not previously available or, conversely disable other terms and conditions that were previously available. At reference numeral 704, a right for hosting the copyrighted material can be included in the contract. Hence, the host can be granted rights to obtain, manage, maintain, or distribute the content.

At reference numeral 706, a right for distributing the content at no cost can be included in the contract, which, oftentimes, is a default condition of the contract. For example, in some cases such as when it is deemed more import to disseminate the work product of the author and/or to improve name recognition, the author's work can be freely accessible. At reference numeral 708, a right for distributing the copyrighted material at a share price of the virtual share. Thus, returning to the music band example, the band might have a number of songs that are quite popular and therefore can be downloaded to a participant's media player for, say, $0.99 cents or some other price, while some of the less well known songs might be downloadable at, e.g., $0.50 or even $0.01. It is to be understood that while prices here are given in U.S. Dollar terms, the virtual share can be denominated in terms of or converted to other currencies.

At reference numeral 710, an obligation for facilitating the sponsorship can be included in the contract. Recall the sponsorship can include funding, promoting, managing, and/or marketing of aspects such as putting the author on tour, physically printing the copyrighted material in a retail grade format and/or distributing the printed copyrighted material to retailers or media outlets. At reference numeral 712, a portion of the earnings or proceeds resulting from the sponsorship can be allocated to an owner of the virtual share. In addition, other proceeds can be distributed to both the host and the author based potentially upon terms and conditions of the contract provided at act 702.

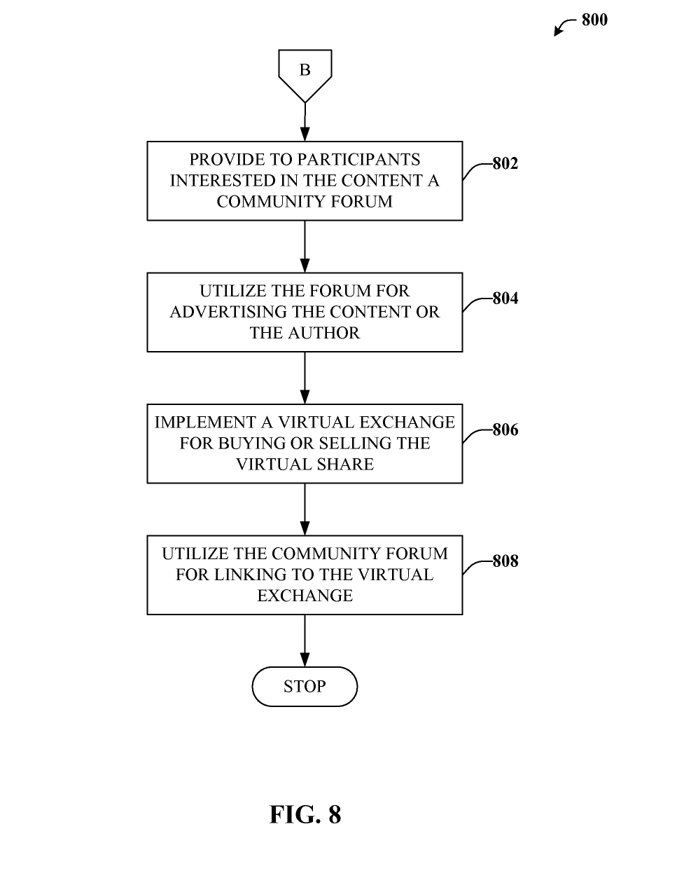

Turning briefly to FIG. 8, computer implemented method 800 for facilitating additional aspects in connection with facilitating sponsorship of authors and/or associated authored content is illustrated. At reference numeral 802, a community forum can be provided to participants interested in the content obtained at reference numeral 606 of FIG. 6. It is to be appreciated that participants can be interested in the particular content, interested more generically in that particular content type, interested in merely browsing content, interested in purchasing virtual share for content, etc. It is to be further appreciated that the community forum can be substantially any electronic forum and can include spaces for and designed by, moderated, and/or maintained by individual participants.

At reference numeral 804, the community forum can be utilized for advertising at least one of the content or the author. For instance, a participant that is pleased with particular content can add that content to his or her own space, site, or blog. Such an addition can include information intended to promote the author as well as a reference to investing in the author (or associated content) by way of purchasing one or more virtual shares.

At reference numeral 806, a virtual exchange can be implemented for at least one of buying or selling the virtual share. The virtual exchange can be implemented as a repository for the virtual shares that sell at a fixed price, at a price that sometimes changes based upon the popularity of the content, implemented as a dynamic exchange where the price can change as a function of supply and demand, or combinations thereof. At reference numeral 808, the community forum can be employed for linking to the virtual exchange, whereby participants can purchase (and potentially sell or short) virtual shares.

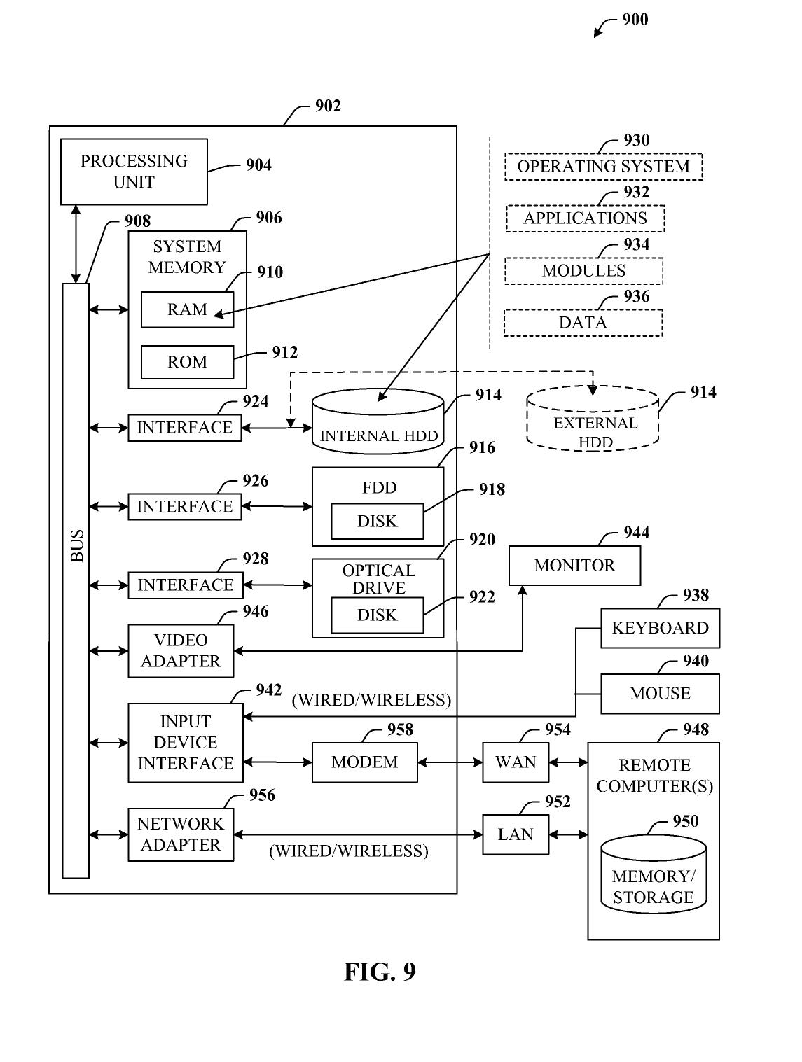

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic 10 BaseT wired Ethernet networks used in many offices.

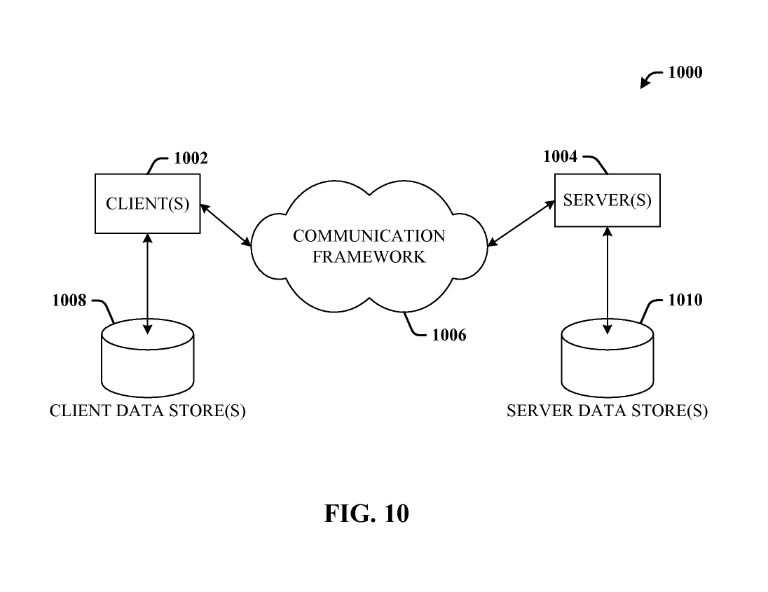

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that facilitates sponsorship of at least one creative entity asset of a set, the set comprising authors and associated authored content, comprising:
a registration component that registers an author for listing and that issues a virtual share;
a hosting component that receives content associated with the author, the content includes copyrighted material, the hosting component provides access to portions of the content;
a sponsorship component that selects the creative entity asset for a sponsorship based upon performance of the virtual share; and
a virtual exchange component that lists the virtual share for sale at a share price.

2. The system of claim 1, wherein the virtual share issued is associated with at least one of the author or the copyrighted material.

3. The system of claim 1, wherein the virtual share entitles an owner to access the copyrighted material.

4. The system of claim 1, further comprising a contract generation module configured to generate a contract that includes terms and conditions associated with listing, wherein the registration component is further configured to transmit the contract to the author.

5. The system of claim 4, wherein the terms and conditions include a right to host the copyrighted material.

6. The system of claim 4, wherein the terms and conditions include a right to distribute the copyrighted material free of charge.

7. The system of claim 4, wherein the terms and conditions include a right to distribute the copyrighted material at a share price of the virtual share.

8. The system of claim 4, wherein the terms and conditions include an obligation to facilitate the sponsorship based upon performance of the virtual share.

9. The system of claim 1, wherein the hosting component provides facilitates access to a community forum for participants interested in the content.

10. The system of claim 9, wherein the community forum is configured to receive data that enables the participants to promote or advertise at least one of the author or the content.

11. The system of claim 10, wherein the community forum includes a link to facilitate a sale of the virtual share to participants interested in the content.

12. The system of claim 1, wherein the hosting component interfaces with an existing community forum.

13. The system of claim 1, the sponsorship includes funding, marketing, promoting, or managing at least one of a set of sponsorship activities, the set comprising a tour for the author, physically printing or distributing portions of the content.

14. The system of claim 13, wherein the set of sponsorship activities generates earnings, at least a portion of the earnings is allocated to an owner of the virtual share.

15. The system of claim 1, wherein the virtual exchange receives from a participant a bid for the share at a bid price.

16. The system of claim 1, the virtual exchange receives from a share owner a sell for the share at an ask price.

17. A computer implemented method for facilitating sponsorship of authors or copyrighted material associated with the authors, comprising:
registering an author for listing on a virtual exchange;
generating a virtual share associated with the registering;
obtaining content associated with the author, the content including copyrighted material;
granting to participants access to portions of the content; and
selecting for sponsorship at least one of the author or the copyrighted material based upon performance of the virtual share.

18. The method of claim 17, further comprising at least one of the following acts:
constructing a contract in connection with the act of registering;
including in the contract a right for hosting the copyrighted material;
including in the contract a right for distributing the copyrighted material at no cost;
including in the contract a right for distributing the copyrighted material at a share price of the virtual share;
including in the contract an obligation for facilitating the sponsorship, the sponsorship including at least one of facilitating a tour for the author or physically printing the copyrighted material; or
allocating a portion of the proceeds of the sponsorship to an owner of the virtual share.

19. The method of claim 17, further comprising at least one of the following acts:
providing to participants interested in the content a community forum;
utilizing the community forum for advertising at least one of the content or the author;
implementing a virtual exchange for at least one of buying or selling the virtual share; or
utilizing the community forum for linking to the virtual exchange.

20. A computer implemented method for facilitating sponsorship of authors or associated authored content, comprising:
associating at least one virtual share with a creative asset virtualized as a financial instrument;
offering the at least one virtual share for sale on a virtual exchange at a sale price;
updating the virtual exchange upon purchase of the at least one virtual share, wherein the updating comprises one of:
issuing a new virtual share at a static price and listing the new virtual share on the virtual exchange at the static price; or
increasing the sale price dynamically;
measuring performance of the virtual share based upon at least one of a number of new virtual shares issued or the sale price; and
choosing the creative asset for sponsorship based upon performance of the virtual share, wherein the sponsorship includes funding, marketing, promoting, or managing at least one of a set of sponsorship activities, the set comprising a tour for the creative asset, physically printing or distributing portions of the creative asset.
